(19) United States
(12) Patent Application Publication
(10) Pub. No.: US 2005/0098045 A1
(43) Pub. Date: May 12, 2005

(54) Heat saving cooking utensil

(76) Inventor: George R. Royer, Toledo, OH (US)

Correspondence Address: George R. Royer, Suite 416, 316 N. Michigan Street, Toledo, OH, 43614, US

(21) Appl. No.: 10/704,242

(22) Filed: Nov. 10, 2003

(51) Int. Cl. A47J 37/12

(52) U.S. Cl. 99/403

(57) ABSTRACT

The subject device is novel cooking utensil for gas, electric or other types of stove, which have an upper stove surface wherein such burners have a relatively flat upper surfaces with an upper perimeter edge and upwardly directed heating units, such cooking utensil having a circumferentially disposed outer extension extending out from the side surface of the utensil which holds an enclosed chamber in which can be contained a liquid that can be heated directly or indirectly from one of the burners to help heat the sides of the utensil.

### DESCRIPTION OF PRIOR ART

In conventional stove structures, the burner units are usually flush with the upper surface of the stove, or in some cases, may be raised slightly above the upper surface of the stove. The overall upper surface diameter of such stove top burner is frequently larger than the bottom diameter of the cooking utensil. In such circumstances, the burner unit is giving off more heat than is necessary to heat the cooking utensil.

More specifically, a major heat conservation problem encountered with conventional stove surface burners that have upper surface diameters that are larger than the diameter of the cooking utensil that is placed over the top of the burner, is that a substantial amount of heat is wasted in the cooking process. In this cooking process, heat is absorbed only by the bottom of the cooking utensil and the heat from surface areas of the burner that are not covered by the bottom of the cooking utensil rises up around the sides of the cooking utensil and little of this heat is absorbed by the sides of the cooking utensil and is therefore not useful in the cooking process. Such heat is therefore wasted in the process. This wasted heat represents a loss of energy that could be otherwise used to help heat the cooking utensil in the process.

The overall disadvantages in such heat loss is obvious and are of such a nature that particular improvements in the structure of cooking utensils and cooking stoves will improve the efficiency and performance of the heat output and utilization in the cooking process.

### OBJECTS

It is an object of the subject invention to provide an improved construction for cooking utensils as used for cooking purposes;

Still another object of the subject invention is to provide an improved energy efficient cooking -utensil;

Another object of the subject invention is to provide an improved structure for a cooking pan;

Still another object of the subject invention is to provide an improved energy utilization structural arrangement for cooking utensils;

Yet another object of the subject invention is to provide an improved device and system of conserving heat from a stove in the process;

A further object of the subject invention is to provide an improved cooking utensil structure that provides optimal energy conservation in the cooking process;

A further object of the subject invention is to provide an improved cooking utensil for energy conservation purposes;

Yet another object of the subject invention is to provide an improved cooking utensil

Other and further objects of the subject invention will become apparent from a reading of the description taken in conjunction with the claims,

### DRAWINGS

FIG. 1 is a top elevational view of a stove burner to which the subject invention may be applicable

FIG. 2 is a perspective view of a cooking utensil incorporating the subject invention;

FIG. 3 shows a cross sectional view of a cooking utensil showing the added portion around the sidewall of the utensil showing the internal chamber to hold liquid to be heated by the burner unit.

FIG. 4 is a side elevational view, in cross sectional configuration, showing schematically how heat is lost from a stove burner unit when the utensil covers only a portion of such burner.

### DESCRIPTION OF GENERAL EMBODIMENT AND SUMMARY OF INVENTION

The subject device is a novel cooking utensil for gas, electric or other types of stoves which have an upper stove surface with standard burners on the upper stove surface, such cooking utensil having a circumferentially disposed radially outwardly extending outer portion that circumferentially flanks the sidewall of the utensil in whole or in part and wherein the bottom surface of such outer portion is adapted to rest upon the upper surface of the burner in order to absorb upwardly heat rising up from that part of the burner not covered by the utensil to heat the sides of the utensil on the stove burner.

Stated alternatively, the subject invention relates to cooking utensils that are heated on the stovetop burners or similiar appliances that are used to heat the contents of a cooking utensil. In this respect, the subject invention is applicable to both cooking utensils and any intermediate devices used to facilitate the transfer of heat to the cooking utensil In this latter respect, the subject invention has application to any types of stoves, including electric, gas, ceramic type stoves and similar types of cooking stoves. In general, the utensil on which this invention is focused has an enclosed or partially enclosed chamber affixed partly around or fully around the side circumference of the utensil. Such chamber is adapted to hold a gas or liquid, or other substance and receive heat from the burner unit portion not covered by the bottoms of the utensil

### DESCRIPTION OF SPECIFIC EMBODIMENT

The following description of the subject invention covers one embodiment and description of such and particular embodiment shall not restrict the breadth of the invention, as set forth in the claims to such specific embodiment.

The subject device is a novel cooking utensil for gas, electric or other types of stoves which have an upper stove surface with standard burners on the upper stove surface, such cooking utensil having a circumferentially disposed radially outwardly extending outer portion that circumferentially flanks the sidewall of the utensil in whole or in part and wherein the bottom surface of such outer portion is adapted to rest upon the upper surface of the burner in order to absorb upwardly heat rising up from that part of the burner not covered by the utensil to heat the sides of the utensil on the stove burner.

Stated alternatively, the subject invention relates to cooking utensils that are heated on the stovetop burners or similar appliances that are used to heat the contents of a cooking utensil. In this respect, the subject invention is applicable to both cooking utensils and any intermediate devices used to facilitate the transfer of heat to the cooking utensil. In this latter respect, the subject invention has application to any types of stoves, including electric, gas, ceramic type stoves and similar types of cooking stoves. In general, the utensil on which this invention is focused has an enclosed or partially enclosed chamber affixed partly around or fully around the side circumference of the utensil. Such chamber is adapted to hold a gas or liquid, or other substance and receive heat from the burner unit portion not covered by the bottoms of the utensil.

As can be seen in the drawings, a stove top 10 is shown in part as having an upper surface 20. Stove 10 can utilize any type of heating system for heating the burner elements; such as, electrical gas, or any other type of energy source. Moreover, the subject invention can be adapted to stoves in which the burner members are ceramic, glass, metallic electric elements or gas fed, resistance coils, or any other types of burner elements. In this respect the invention is made applicable to burner units having upper surfaces that are generally flat on the upper portion thereof or even with burner units that have upwardly extending burner units.

More specifically, for an initial and base perspective, the invention herein is applicable to a conventional cooking stove, such cooking stove having an upper surface 20 which is a cooking surface into which surface is integrated the heating elements forming burner units such as burner unit 30 as shown to provide the requisite heat for the various cooking utensils. For purpose of describing this specific embodiment of the subject invention, cooking stove 10 will be described and shown as a stove having an upper cooking surface 20 and incorporating and utilizing one or more electrical heating burners such as burner unit 30, which functions as one or more of the heating elements for stove 10. As stated above, the subject invention is equally applicable to other stove types using gas or other forms of heat source, transfers or exchange as the heating mediums. Thus, the following description of an electrically based stove 10 with flat burner will be considered one specific embodiment and will not be construed as limiting the scope of the subject invention.

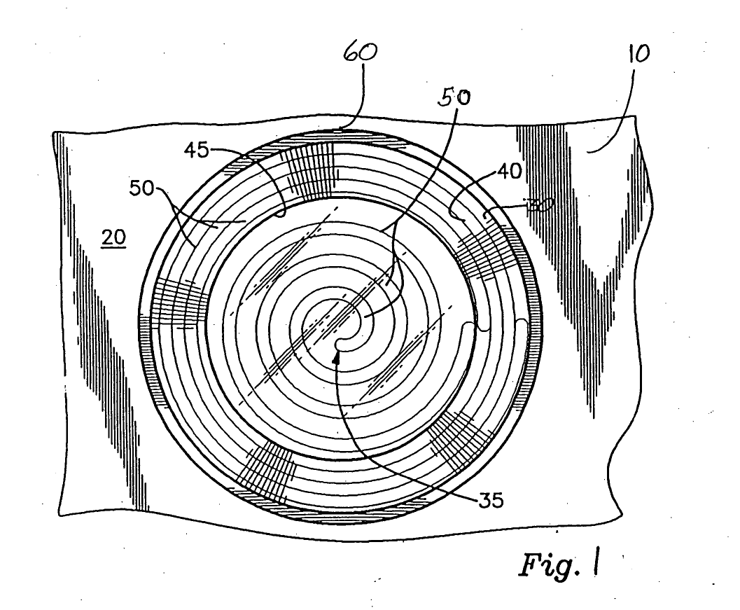

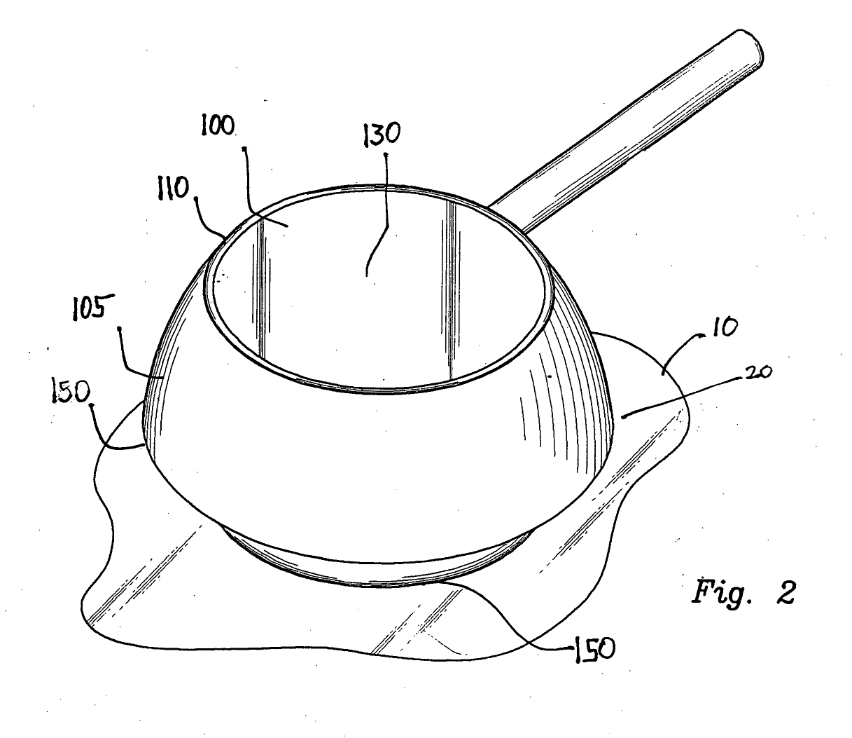

Referring again to the drawings and particularly FIGS. 1 and 2. As seen, a stove 10 is shown with an upper cooking surface 20 having at least one burner unit 30 on such upper surface 20 of stove 10. The number of such burners used in the upper surface 20 of stove 10 is inconsequential to the construction of the subject apparatus and invention therein, as the concept herein can apply on any such burner. Burner 30 is comprised, in this example, of a coiled heating element 40 having an inner end 35, with the looped coil members having abbreviated vertical sides, such as side portion 45. The upper surfaces 50 of the coil are usually flat. Moreover, the burner unit has an outer perimeter 60 defining the radially outer limits of the burner that shows the burner unit can have any geometric shape other than that shown in the diagram.

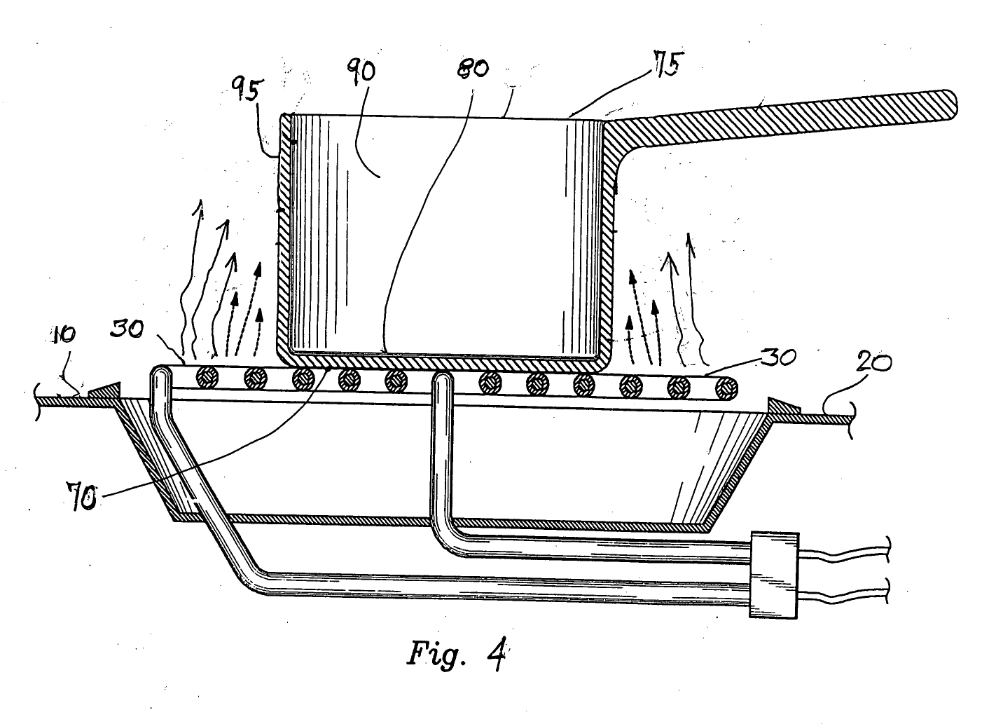

As seen in FIG. 4, burner 30 is basically and essentially flush with the upper surface 20 of the stove 10 such that only a bottom portion 70 of a conventional cooking utensil 75 is placed on the top of such flat burner surface to be heated for cooking purposes. In this position heat from burner 30 is transferred to only the under bottom of the utensil 75 to the inside bottom surface 80 up to the side spatial area 90 of the utensil 75, with attendant loss of heat up and around the side of the utensil from the uncovered portion of the burner 30, as shown schematically in FIG. 4. This loss of heat is a result, as seen in FIG. 4, of the fact that the utensil bottom portion 70 does not generally cover the entire portion of the burner unit 30. This heat is significantly wasted and the subject invention, as described herein, is created to capture this residual heat rising off the burner 30 around the outer sides 95 of the utensil 75, demonstrated in FIG. 4.

The purpose of the invention and structure herein, as more fully described below, is to prevent as much heat as possible from radiating up into the air from the burner 30 on which a cooking utensil is placed, and prevent or mitigate as much as possible any heat rising unused from the burner 30 and prevent thereby the heat loss phenomena shown graphically in FIG. 4. By this arrangement, the feature of the modified cooking utensil described below will capture and use as much heat form burner 30 as possible to heat the utensil 100. As stated, this modification addition to utensil 100 will help capture a substantial portion of the heat that would otherwise rise up around outer side surface areas of the utensil 100 and this captured heat will help heat the inside contents of the utensil 100 to a greater degree. This will not only save heat but will also expedite the cooking process.

Specifically, the invention concept herein incorporates the concept of using modified cooking utensil structured and adapted to conserve heat that rises upwardly from the burner 30 around the side of the cooking utensil to help prevent unused heat from the burner rising upwardly into the atmosphere or room, and instead to capture and use such escaping heat to maximize heat input onto the cooking utensil's outside circumference. The result of such a heating process helps to minimize the heat loss in the cooking process, and use such heat to more efficiently in the cooking process.

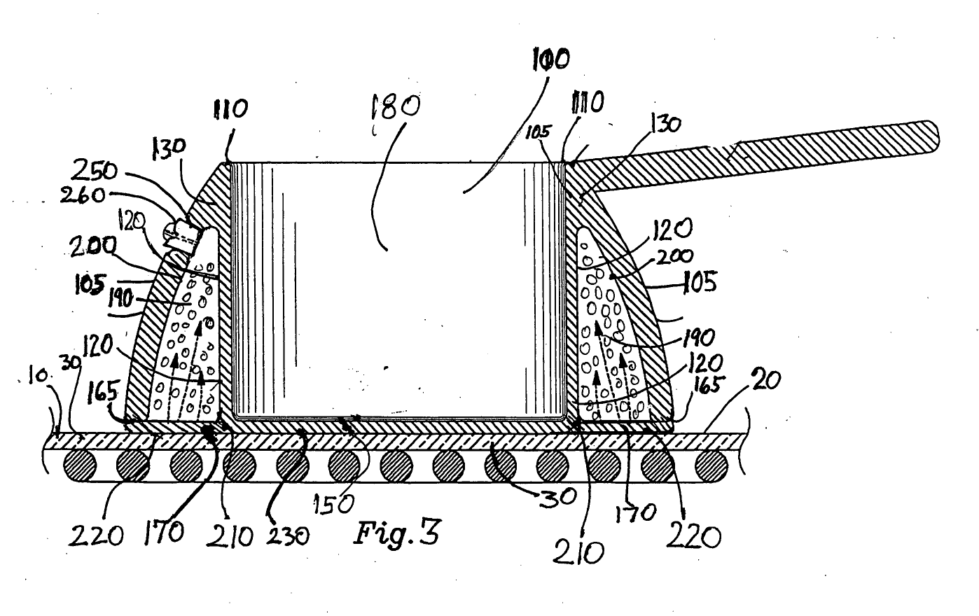

As seen in FIGS. 2 and 3, in order to incorporate the latter concepts into a cooking utensil, or other comparable cooking device, an otherwise conventionally structured cooking utensil 100 has integrated thereon an outer circumferential skirt like flange extension 105, the upper portion of which circumferential flange; extension optimally is affixed at or near the upper rim portion 110 of the utensil 100, and which skirt-like flange extension is optimally flared radially outwardly as it extends downwardly from the upper rim portion 110 toward its circumferential bottom portion 150. As further seen in FIGS. 2 and 3, the circumferential flange extension 105 is spaced away from the circumferential sidewall 120 of the cooking utensil 100. The particular attribute of this flange extension 105, attachment are more fully described below. For optimal for further reference perspectives description of cooking utensil 100 indicates it has an open area 130 for or food placement for cooking, as well as an outer 120 perimeter side wall, as stated, which is usually rounded, and a generally flat bottom portion 150, which is seated on the burner to receive heat. Those latter attributes are conventional and are set forth for reference purposes in describing the specific embodiment herein.

Alternatively, in the specific embodiment of the subject invention described herein, as shown in FIGS. 2 and 3, the modified cooking utensil 100, incorporating features of this invention, has a circumferentially disposed radially outwardly extending portion 110 with a generally flat bottom portion 120 surrounding all or part of the bottom portion 150 of the cooking utensil 100. As can be seen from the drawings, the upper circumferentially extending rim 130 of the flange extension 105 is disposed all the way around a part of the upper portion of cooking utensil 100. Aside from the flange extension 105, the above described aspects of a cooking utensil 100 are generally conventional features of an ordinary cooking utensil.

More specifically, for purposes of implementing the foregoing objectives, the circumferentially radially outwardly extending flange extension is joined on its bottom circumferentially edge 165, to a circumferential flat portion bottom 170 which extends radially inwardly to be joined circumferentially at or neat the bottom perimeter rim 175 of utensil 100, such perimeter rim being also the outer perimeter rims of the bottom surface portion of the utensil 100. This latter bottom portion 170 together with the outwardly extending flange extension 105 form an enclosed circumferentially extending spatial area 190 which abuts the lateral sidewalls 120 of the utensil 100. More particularly, this enclosed circumferentially extending spatial area 190 thus extends all around the outer side walls 120 of utensil 100.

As indicated, the outer surface of the circumferential side wall 120 of the utensil 100 is conventionally structured and may be straight up and down as seen in FIG. 3 or it may be angled with a tapering radially inwardly. The outer surface 120 of the side wall 120 of utensil 100 may be shaped other than that shown in FIGS. 3 and may be other than round as described and may be elliptical, rectangular, or of another shape as seen from a top or bottom elevational view. In any case, the utensil has an interior cooking space 180 surrounded by the sidewall 120

Alternately stated, utensil 100 has an outer circumferentially extending flange extension member 105 has an upper circumferential rim portion 130 and a lower circumferential rim portion 165, with such upper circumferential rim 130 of such flange member 105 being joined in a circumferential manner around a circumferential portion of the outer circumferential side 120 of such utensil 100, with the bottom circumferential rim portion 165 being spaced an arbitrary distance from the outer circumferential side 120 of such utensil 100. This latter spacing arrangement forms thereby a spatial area 190 between the outer circumferential surface 120 of the utensil 100 and the inner surface 200 of the circumferential flange extension 105, which spatial area 190 is further enclosed on the bottom thereof by a solid continuous bottom portion 170 extending radially inwardly between the lower rim portion 175 of such flange extension 105 and the nearest adjacent circumferential side surface portion of the side surface 120 of the utensil 100. Optimally the radially inner portion 210 of the bottom flat member 170 is joined to the sidewall 120 of utensil 100 near the bottom rim portion of the utensil 100, so that the under surface 220 of the flat bottom portion, is even with the bottom surface of the of the utensil 100. Thus, when the utensil 100 is placed on burner 30 and heated on the burner, the bottom surface 220 of the flat portion 170 also rests flush against the upper inner surface and collects heat from those portions of the burner that are not covered.

Stated yet another way, the subject invention is a cooking utensil member 100 with a flange extension 105, as attached in a circumferential manner to a circumferential portion of the external circumferential side surface 120 of the cooking utensil 100. Alternately utensil 100 is structured to have an internal chamber 190 which chamber is inside or part of the sidewall 100 and is within such sidewall or otherwise disposed circumferentially around the sides of utensil 100. The inner wall of such spatial area 190 is otherwise adjacent to the side wall 120 of such utensil 100, such spatial chamber 190 being enclosed by a flat bottom portion 170 connected to the bottom of such flange extension and the utensil wall 120. Such bottom portion 170 extends preferably radially out from the bottom most side of such utensil 100 in a perpendicular manner so that the bottom surface 220 of the bottom portion 170 is preferably even or level with the bottom surface 230 of the utensil 100. This enclosed chamber area 190-is adapted to receive water or other heat conducting liquids or other substances through an opening 250 which has an enclosed cap 260 through which excess steam can escape.

Once the enclosed chamber area 190 is filled with water the utensil 100 is placed on a stove, and the stove will heat the bottom 150 of the utensil 100 as well as the bottom surface 220 portion of the flat bottom 170. The result will be that water in the enclosed chamber 190 will be heated in addition to the contents of the utensil. As the water in the enclosed spatial chamber 190 is heated, it will heat the sides 120 of the utensil 100 to supplement heat impact on the bottom 150 of the utensil 100, and provide extra heat in the cooking process. It should be stressed that in this respect, the bottom portion 170 of the flange extension 105, or of the chamber 190, should be wide enough to cover most of the burner 30 which is not covered by the bottom portion of the utensil proper.

It is also to be stated that the variation of the above structure may include an outer extension member that does not completely surround the utensil, nor does the flange extension 105 need to be flared outwardly towards the bottom, as it can be flared upwardly or extend straight up or down in any shaped configuration.

In summary, the subject invention, a cooling utensil adapted to having a closed bottom surface and having an upwardly circumferential extending side that extends upwardly from the bottom surface in a manner, such surrounding side formerly a closed space with such circumferential extending side having a circumferential flange extending radially outwardly from the circumferential side surface of such utensil with such circumferential flange extension having a bottom surface which encloses the space between such flange extension and side of the cooking utensil which thereby forms an enclosed spatial chamber in which substances can be placed to be heated as a means to heat the sides of the utensil.

Additionally the subject invention is a cooking utensil for placement in a burner on a stove comprising:
(a) a bowl shaped member having a bottom surface with an upwardly extending enclosure surface affixed to such bottom surface, such enclosure surface having an outer surface and forming an open depression in such bowl member into which food is placed for cooking purposes; and
(b) a circumferentially extending flange member affixed radially to such utensil in a perimeter like manner around a portion of such outer surface of such bowl member, such flange member extending radially outwardly from the outer surface of the bowl shaped member, such flange being enclosed outer sides between the sides of the utensil and the flange member, to hold liquids for heating purposes.

Further summarizing, the subject invention is a cooking utensil for a stove burner, to receive a portion of the cooking utensil, which recessed burner has a bottom portion, an internal inside portion and an upper opening having an upper perimeter edge forming the boundaries of such upper opening, comprising:
(a) a cooking utensil having a bottom and a side surface, which side surface has an outer perimeter, which side surface having a circumferential extension around the outer surface of such utensil which has an enclosed chamber to receive liquids to heat the utensil on the sides therein. In the most direct parlance the subject invention focuses on the creation of a closed spatial chamber abutting on the sides of the utensil or part or within the sides of the utensil, such chamber being enclosed in part by a bottom portion the undersurface of which is adapted to be positioned flush against most or all of the burner surface not covered by main utensil bottom This spatial chamber can be simply structured in as part of the sidewall 120 of the utensil 100 and simply be an internal chamber in such sidewall, extending completely around such chamber or partially around such outer side wall, or in any portion thereof Such chamber would have also a bottom portion that could receive heat over that part of the burner which would not otherwise be covered by the utensil bottom

1. A cooking utensil adapted to having a closed bottom surface and having an upwardly extending surrounding side wall that extends upwardly from the bottom surface in a circumferential manner, such surrounding sidewall having an internal chamber in a part thereof which chamber is adapted to receive liquids to be heated supplement heating of the cooking utensil.

2. A supplemental heat absorbing apparatus for a cooking utensil to be heated on a stove burner comprising:
(a) A cooking utensil having a bottom surface with upwardly extending sidewall extending from said bottom surface;
(b) a circumferentially extending flange extension affixed around a portion of said sidewall of said utensil, said flange extension having an inner chamber portion that is adjacent in part to a portion of the sidewall of said utensil said flange extension having means to place liquids into said chamber;
(c) lower surface means on a part of the bottom portion of said flange extension, said means adapted to be placed adjacent to said stove burner to receive heat from said structural stove burner;

3. A supplemental heat absorbing apparatus for a cooking utensil to be heated on a stove burner comprising:
(a) a cooking utensil having a bottom surface with upwardly extending sidewall extending from said bottom surface;
(b) a circumferentially extending flange extension affixed around a portion of said sidewall of said utensil said extension flange having an inner chamber portion that is adjacent in part to a portion of the sidewall of such utensil, said flange extension having means to place liquids into said chamber, and wherein said flange extension has a bottom portion;
(c) lower surface mans on a part of said bottom portion of said flange extension to receive heat from said burner, said bottom portion being aligned with said bottom surface of said utensil.
